(19) United States
(12) Patent Application Publication
(10) Pub. No.: US 2021/0229191 A1
(43) Pub. Date: Jul. 29, 2021

(54) ROTARY CUTTING TOOL FOR FORMING MULTIPLE SURFACES

(71) Applicant: Decatur Diamond LLC, Decatur, IN (US)

(72) Inventors: Gabriel Dontu, Ann Arbor, MI (US); Kirk Bennett, Tipp City, OH (US)

(21) Appl. No.: 17/156,132

(22) Filed: Jan. 22, 2021

Related U.S. Application Data
(60) Provisional application No. 62/965,604, filed on Jan. 24, 2020.

(51) Int. Cl. B23C 5/10; B23D 77/12

(52) U.S. Cl. CPC B23C 5/10; B23D 77/12; B23C 2210/32; B23C 2210/40; B23C 2210/0407

(57) ABSTRACT

A rotary cutting tool is provided that includes a shank and a body. The body extends axially outwardly from the shank, and has a plurality of first teeth and a plurality of second teeth. The first and second teeth are alternately arranged and spaced apart from one another around a circumference. Each first tooth includes a primary cutting edge disposed at a primary angle relative to the rotational axis and a tertiary cutting edge disposed at a tertiary angle relative to the rotational axis. Each second tooth includes a secondary cutting edge disposed at a secondary angle relative to the rotational axis. The secondary cutting edge is disposed axially between the primary cutting edge and the tertiary cutting edge.

This application claims priority to U.S. Patent Appln. No. 62/965,604 filed Jan. 24, 2020, which is herein incorporated by reference in its entirety.

### BACKGROUND OF THE INVENTION

### 1. Technical Field

The present invention relates to rotary cutting tools in general, and to rotary cutting tools configured to form multiple surfaces in particular.

### 2. Background Information

Rotary cutting tools can be used to produce a bore geometry with a plurality of independent surfaces. A non-limiting example of a bore geometry with a plurality of independent surfaces is a valve seat. FIG. 1 illustrates a valve and valve seat combination for an internal combustion engine. The valve seat includes a plurality of surfaces, one of which (i.e., the “sealing surface”) is contacted by an intake or exhaust valve during a portion of the engine operating cycle when the valve is closed. The physical characteristics of the valve seat are critical to engine performance. If a valve seat is improperly positioned or configured during manufacture, the valve and valve seat will not seal and engine performance will be adversely affected.

A “three-angle” valve seat is diagrammatically shown in FIG. 2. A three-angle valve seat may be described as having primary, secondary, and tertiary annular surfaces (each sometimes referred to as a conical surface). Each of the aforesaid surfaces is centered on an axis (“A”) that coincides with the axial movement of the valve. The primary surface is the first encountered surface (e.g., closest to the cylinder combustion chamber), then the secondary surface, and then the tertiary surface. The secondary surface (i.e., the valve sealing surface) is disposed between and contiguous with each of primary and tertiary surfaces. Typically, the primary surface angle (“PSA”) is shallower than secondary surface angle (“SSA”), and the secondary surface angle is shallower than the tertiary surface angle (“TSA”); i.e., PSA<SSA<TSA. The angular transition between the conical valve seat surfaces facilitates fluid flow into the combustion chamber (intake valve) and out of the combustion chamber (exhaust valve), thereby improving the performance of the engine.

Conventional rotary cutting tools configured to produce a multiple surface configuration like a valve seat often include independent cutting teeth for each surface to be formed. For example, a prior art rotary cutting tool may have a pair of first teeth disposed to cut the primary surface, a pair of second teeth disposed to cut the secondary surface, and a pair of third teeth disposed to cut the tertiary surface. A disadvantage of this type of cutting tool arrangement is that the number of teeth that can be deployed around the circumference of the rotary cutting tool is limited; e.g., each tooth is circumferentially displaced from other cutting teeth, and for a given rotary cutting tool circumference, the number of circumferential positions is limited. The limited circumferential space issue is particularly acute for those prior art cutting tools that use cartridge mounted teeth. The cartridges facilitate removal and replacement of worn teeth, but take up a considerable amount of circumferential space, and in some instances can produce tool set up issues.

What is needed is a rotary cutting tool having cutting elements that can be used to create a plurality of independent surfaces without the limitations of the prior art.

### SUMMARY

According to an aspect of the present disclosure, a rotary cutting tool having a rotational axis is provided that includes a shank and a body. The body extends axially outwardly from the shank. The body has a plurality of first teeth and a plurality of second teeth. The first teeth and the second teeth are alternately arranged and spaced apart from one another around a circumference. Each first tooth includes a primary cutting edge disposed at a primary angle relative to the rotational axis and a tertiary cutting edge disposed at a tertiary angle relative to the rotational axis. Each second tooth includes a secondary cutting edge disposed at a secondary angle relative to the rotational axis. The secondary cutting edge is disposed axially between the primary cutting edge and the tertiary cutting edge.

In any of the aspects described above or herein, the secondary angle may be different from the primary angle and the tertiary angle.

In any of the aspects described above or herein, the primary angle may be different from the tertiary angle.

In any of the aspects described above or herein, the primary cutting edge and the tertiary cutting edge may be axially separated from one another.

In any of the aspects described above or herein, the primary cutting edge and the secondary cutting edge may axially intersect one another.

In any of the aspects described above or herein, the tertiary cutting edge and the secondary cutting edge may axially intersect one another.

In any of the aspects described above or herein, the rotary cutting tool may further comprise a plurality of flutes, each said flute disposed between an adjacent one said first tooth and a one said second tooth.

In any of the aspects described above or herein, the rotary cutting tool may include one or more coolant passages extending within the body.

In any of the aspects described above or herein, the one or more coolant passages may include at least one passage in fluid communication with an exit port disposed within a flute.

In any of the aspects described above or herein, the rotary cutting tool may include a first axial end and a second axial end opposite the first axial end, and the shank may extend between the first axial end and the body, and the plurality of first teeth and the plurality of second teeth may be disposed within a first cutter head portion, and the body may include a second cutter head portion extending from the second axial end toward the first cutter head portion.

In any of the aspects described above or herein, the second cutter head portion may include a reamer.

In any of the aspects described above or herein, the rotary cutting tool may include a first portion and a second portion that are fixed to one another, the first portion including the shank and at least a segment of the body, wherein the first portion is formed of a first material and the second portion is formed of a second material, and the first material is different from the second material.

In any of the aspects described above or herein, each first tooth may include a first tip fixed thereto, and the first tip is configured to include the primary cutting edge and the tertiary cutting edge, and each second tooth may include a second tip fixed thereto, and the second tip is configured to include the secondary cutting edge.

In any of the aspects described above or herein, each first tooth may include a first cutting insert mechanically attached to the first tooth, and the first cutting insert is configured to include the primary cutting edge and the tertiary cutting edge, and each second tooth may include a second cutting insert mechanically attached to the second tooth, and the second cutting insert is configured to include the secondary cutting edge.

According to an aspect of the present disclosure, a rotary cutting tool having a rotational axis is provided. The rotary cutting tool includes a shank and a body. The body has a plurality of first teeth and a plurality of second teeth. The first teeth and second teeth are alternately arranged and spaced apart from one another around a circumference. Each first tooth includes a primary cutting edge disposed at a primary angle relative to the rotational axis and a tertiary cutting edge disposed at a tertiary angle relative to the rotational axis. Each second tooth includes a secondary cutting edge disposed at a secondary angle relative to the rotational axis. The primary cutting edge, the secondary cutting edge, and the tertiary cutting edge are configured such that rotation of the tool and engagement of the tool into a workpiece causes: the primary cutting edge and the secondary cutting edge to form a primary surface and a secondary surface in a work piece, the primary surface and the secondary surface contiguous with one another; and the tertiary cutting edge to form a tertiary surface in the work piece, the secondary surface and the tertiary surface contiguous with one another; and the primary surface axially separated from the tertiary surface.

In any of the aspects described above or herein, the secondary angle may be different from the primary angle and the tertiary angle, the primary angle may be different from the tertiary angle, and the primary cutting edge and the tertiary cutting edge may be axially separated from one another.

In any of the aspects described above or herein, the primary cutting edge and the secondary cutting edge may axially intersect one another, and the tertiary cutting edge and the secondary cutting edge may axially intersect one another.

In any of the aspects described above or herein, the rotary cutting tool may include a plurality of flutes, each said flute disposed between an adjacent one said first tooth and a one said second tooth.

In any of the aspects described above or herein, the rotary cutting tool may include a first axial end and a second axial end opposite the first axial end, and the shank may extend between the first axial end and the body, and the plurality of first teeth and the plurality of second teeth may be disposed within a first cutter head portion, and the body may include a second cutter head portion extending from the second axial end toward the first cutter head portion.

In any of the aspects described above or herein, the second cutter head portion may include a reamer.

### BRIEF DESCRIPTION OF THE DRAWINGS

FIG. 1 is a diagrammatic sectional view of a valve and valve seat.

FIG. 2 is a diagrammatic sectional view of a valve seat.

FIG. 3 is a perspective view of a rotary cutting tool embodiment.

FIG. 4 is an end view of a rotary cutting tool embodiment.

FIG. 5 is a side view of a rotary cutting tool embodiment.

FIG. 6 is an expanded partial view of portion of the rotary cutting tool embodiment shown in FIG. 5.

FIG. 6A is an expanded partial view of portion of the rotary cutting tool embodiment shown in FIG. 5, including a cutting insert.

FIG. 7 is a side view of a rotary cutting tool embodiment.

FIG. 8 is an expanded partial view of portion of the rotary cutting tool embodiment shown in FIG. 7.

FIG. 8A is an expanded partial view of portion of the rotary cutting tool embodiment shown in FIG. 7, including a cutting insert.

FIG. 9 is a diagrammatic sectional partial view of a valve seat.

FIG. 10 is a diagrammatic sectional side view of a rotary cutting tool embodiment.

FIG. 11A is chart of tooth versus circumferential position.

FIG. 11B is chart of tooth versus circumferential position.

### DETAILED DESCRIPTION

The present disclosure is directed to a rotary cutting tool configured to produce a workpiece bore geometry with a plurality of independent surfaces. The term “plurality of independent surfaces” as used herein means at least three surfaces; i.e., at least a primary surface, a secondary surface, and a tertiary surface. The secondary surface is disposed between and is contiguous with the primary surface and the tertiary surface; i.e., the secondary surface extends axially between the primary and tertiary surfaces. The primary and tertiary surfaces are axially separated from one another.

The present disclosure rotary cutting tool can be configured in a variety of different embodiments that may be used for a variety of different applications. The rotary cutting tool has first teeth and second teeth. Each first tooth is configured to cut a primary surface and a tertiary surface. Each second tooth is configured to cut a secondary surface. A plurality of the first teeth and a plurality of the second teeth are disposed around the circumference of the rotary cutting tool. The first teeth (“FT”) and second teeth (“ST”) are alternately disposed around the circumference of the rotary cutting tool (i.e., FT, ST, FT, ST, etc.). The first and second teeth may be uniformly spaced apart from one another around the circumference of the tool, but the present disclosure is not limited to uniformly spaced teeth. Each first tooth includes a primary cutting edge and a tertiary cutting edge. The primary cutting edge is disposed at a primary surface angle. The tertiary cutting edge is disposed at a tertiary surface angle. Each second tooth has a secondary cutting edge disposed at a secondary surface angle. Each of the respective surface angles may be defined as an included angle between the respective cutting edge and a radial line extending perpendicular to the rotational axis of the rotary cutting tool, or alternatively as an included angle between the respective cutting edge and the rotational axis. The primary and tertiary surface angles are different from the secondary angle. Depending on the application, the rotary cutting tool may be configured so that the primary, secondary, and tertiary angles are all different from one another. The primary cutting edge and the tertiary cutting edge are axially separated from one another. In some embodiments, the primary cutting edge and the tertiary cutting edge may intersect one another within a first tooth. The secondary cutting edge is disposed axially between the primary and tertiary cutting edges. The primary cutting edge and the secondary cutting edge axially intersect one another (but are circumferentially separated from one another); e.g., the primary cutting edge is circumferentially separated from the secondary cutting edge, and the primary cutting edge and the secondary cutting edge axially overlap one another. The secondary cutting edge and the tertiary cutting edge axially intersect one another (but are circumferentially separated from one another); e.g., the secondary cutting edge is circumferentially separated from the tertiary cutting edge, and the secondary cutting edge and the tertiary cutting edge axially overlap one another. The relative positions of the primary, secondary, and tertiary cutting edges are such that during use of the rotary cutting tool, the primary and secondary cutting edges form contiguous primary and secondary surfaces in the workpiece, and the secondary and tertiary cutting edges form contiguous secondary and tertiary surfaces in the workpiece.

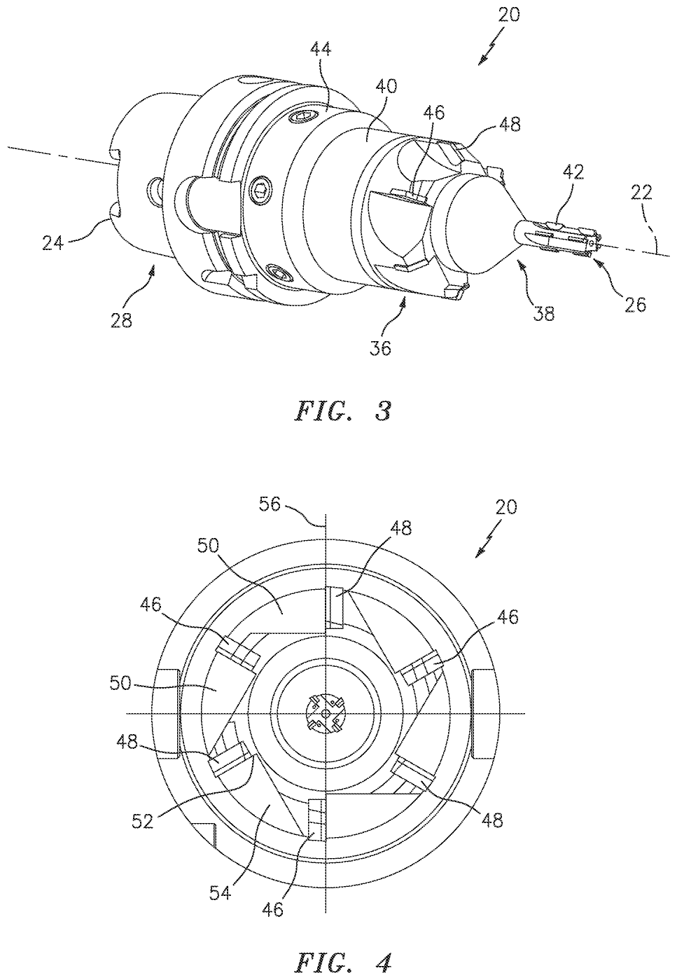

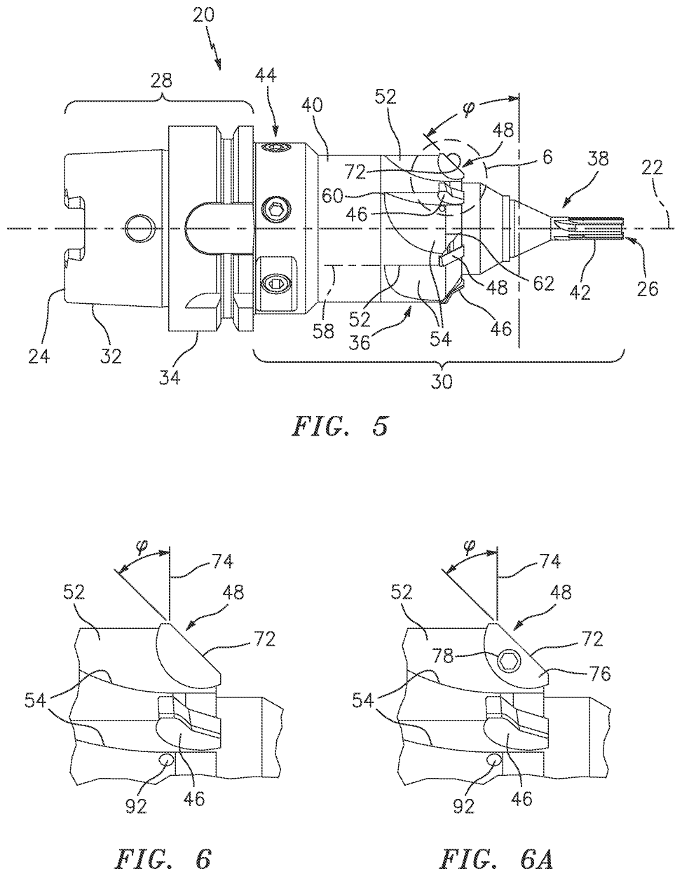

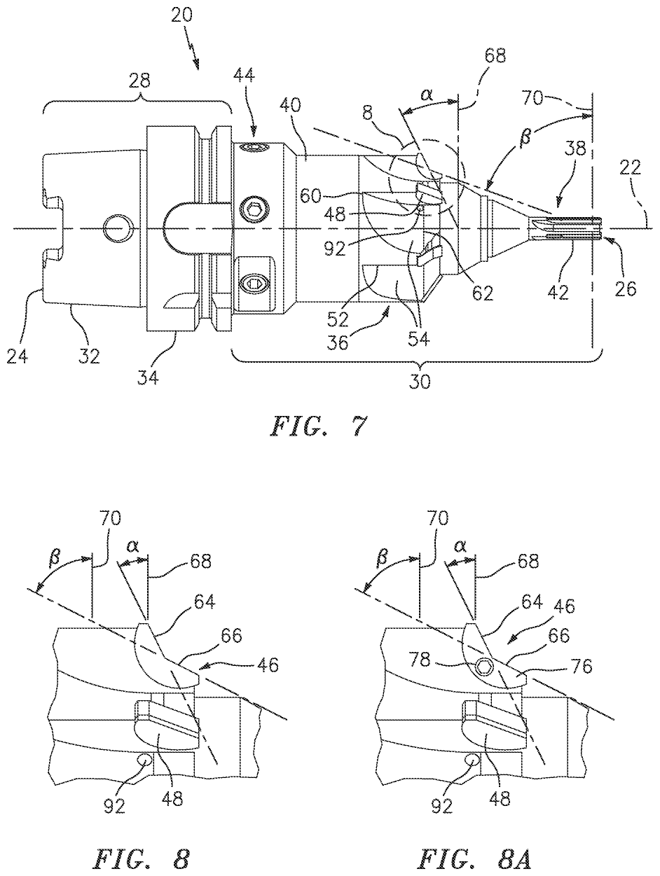

Non-limiting examples of a present disclosure rotary cutting tool are shown in FIGS. 3-8 in the form of valve seat cutting tool embodiments. The rotary cutting tool 20 axially extends along a rotational axis 22 between a first axial end 24 and an opposite second axial end 26. The rotary cutting tool 20 includes a shank 28 and a body 30. The shank 28 extends axially from the first axial end 24 of the rotary cutting tool 20 to the body 30. The embodiments shown in FIGS. 3, 5, and 7 include a HSK style shank (i.e., a shank configured to be held within a HSK tool holder system). The HSK style shank includes a tapered portion 32 and a collar portion 34. The present disclosure rotary cutting tools 20 are not limited to any particular type of shank 28 configuration.

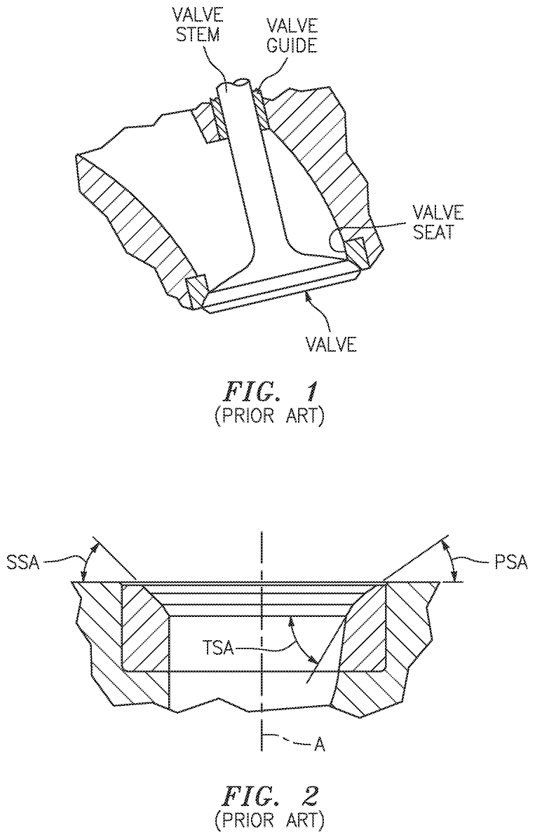

The rotary cutting tool 20 embodiments shown in FIGS. 3, 5, and 7 include a body 30 that extends from the second axial end 26 to the shank 28, and includes a first cutter head portion 36, a second cutter head portion 38, and a body section 40. In alternative embodiments, the rotary cutting tool 20 may include a body having a first cutter head portion 36, without a second cutter head portion 38. The second cutter head portion 38 is disposed adjacent the second axial end 26. In the embodiment shown in FIGS. 3-5 and 7, the second cutter head portion 38 is configured to include a reamer 42 configured to cut, for example, a valve guide (See FIG. 1). The reamer 42 may be an integrally formed portion of the rotary cutting tool body 30 (e.g., the reamer 42 and the body 30 are a homogeneous, unitary structure) or the reamer 42 may be press fit or otherwise mechanically affixed to the rotary cutting tool body 30. The present disclosure is not limited to any particular second cutter head portion 38 configuration.

The body section 40 is disposed axially between the shank 28 and the first cutter head portion 36. In the embodiments shown in FIGS. 3, 5, and 7, the body section 40 includes a mechanism 44 for balancing the rotary cutting tool 20; e.g., a plurality of mechanical features (e.g., screws) disposed around the circumference of the body 30. The present disclosure does not require a balancing mechanism 44. In those embodiments that include a balancing mechanism 44, the balancing mechanism 44 is not limited to the screw embodiment shown.

The first cutter head portion 36 is disposed axially between the body section 40 and the second cutter head portion 38. In the embodiments shown in FIGS. 3-8, the first cutter head portion 36 includes a plurality of first teeth 46 and a plurality of second teeth 48 alternately disposed around the circumference of the rotary cutting tool 20 (i.e., FT, ST, FT, ST, etc.), circumferentially spaced apart from one another. This non-limiting embodiment has three (3) first teeth 46 and three (3) second teeth 48 (six (6) total) uniformly spaced around the circumference. The present disclosure rotary cutting tool 20 is not limited to any particular number of first teeth 46, or second teeth 48, or total number of teeth 46, 48. The present disclosure rotary cutting tool 20 is also not limited to circumferentially uniformly spaced teeth 46, 48.

A flute 50 may be disposed between each first tooth 46 and second tooth 48 pair; e.g., FT, flute, ST, flute, FT, flute, ST, etc. Each flute 50 is configured to facilitate removal of workpiece chips produced during use of the rotary cutting tool 20. The flute 50 embodiments shown in FIGS. 3, 5, and 7 may be described as having a planar face surface 52 and a discharge surface 54. The planar face surface 52 may be defined by a first line 56 extending radially outwardly from the rotational axis 22 of the tool 20 (e.g., see FIG. 4), and a second line 58 extending parallel to the rotational axis 22 of the tool 20 (e.g., see FIG. 5). The discharge surface 54 extends outwardly from the planar face surface 52 (e.g., substantially perpendicular to the planar face surface 52), and at least a portion of the discharge surface 54 may be arcuately shaped. The discharge surface 54 extends from a first axial end 60 disposed at a first radial position to a second axial end 62 disposed at a second radial position (e.g., see FIG. 5). The first axial end 60 of the discharge surface 54 is positioned axially closer to the shank 28 than the second axial end 62, and the first radial position is radially outside of the second radial position. The present disclosure is not limited to any particular flute 50 configuration.

Each first tooth 46 includes a primary cutting edge 64 and a tertiary cutting edge 66. The primary cutting edge 64 is disposed at a primary surface angle “α”. The primary surface angle is shown in FIG. 7 as an included angle “α” between the primary cutting edge 64 and a radial line 68 extending perpendicular to the rotational axis 22 of the rotary cutting tool 20. The tertiary cutting edge 66 is disposed at a tertiary surface angle “β”. The tertiary surface angle is shown in FIG. 7 as an included angle “β” between the tertiary cutting edge 66 and a radial line 70 extending perpendicular to the rotational axis 22 of the rotary cutting tool 20. Each second tooth 48 has a secondary cutting edge 72 disposed at a secondary surface angle “φ”. The secondary surface angle is shown in FIG. 5 as an included angle “φ” between the secondary cutting edge 72 and a radial line 74 extending perpendicular to the rotational axis 22 of the rotary cutting tool 20. The primary and tertiary surface angles α, β are different from the secondary angle φ. Depending on the application, the rotary cutting tool 20 may be configured so that the primary, secondary, and tertiary angles are all different from one another. As a non-limiting example, a present disclosure rotary cutting tool 20 configured to form a three-angle valve seat may have a primary cutting edge 64 disposed at a thirty degree primary surface angle (i.e., α=30°), a secondary cutting edge disposed at a forty-five degree secondary surface angle (i.e., φ=45°), and a tertiary cutting edge 66 disposed at a sixty degree tertiary surface angle (i.e., β=60°). These surface angles are included here to illustrate a rotary cutting tool 20 configured to produce a typical three-angle valve seat, and the present disclosure is not limited to these exemplary surface angles.

In some embodiments, the rotary cutting tool 20 may be configured such that each first tooth 46 and/or each second tooth 48 is formed of a single body of material (e.g., steel or carbide). In these embodiments, each first tooth 46 is formed (e.g., machined) to include the primary cutting edge 64 and the tertiary cutting edge 66, and each second tooth 48 is formed (e.g., machined) to include the secondary cutting edge 72.

In some embodiments, the rotary cutting tool 20 may be configured such that a cutting tip is attached to each first tooth 46 and/or each second tooth 48. For example, a cutting tip (e.g., a body formed independently from the tooth) may be disposed within a pocket (not shown) formed within the respective tooth 46, 48 and attached to the tooth 46, 48; e.g., by a brazing process, or by an adhesive, or other material capable of fixing the cutting tip within the pocket. For those first teeth 46 that include a cutting tip, the cutting tip is formed (e.g., machined) to include the primary cutting edge 64 and the tertiary cutting edge 66. For those second teeth 48 that include a cutting tip, the cutting tip is formed (e.g., machined) to include the secondary cutting edge 72. Alternatively, a cutting tip may be fixed to the respective tooth as described and the respective cutting edge 64, 66, 72 may be formed subsequently. The cutting tips may comprise a different material than that of the respective tooth 46, 48; e.g., the teeth 46, 48 comprising steel and the cutting tips comprising a carbide, or a polycrystalline diamond (PCD) material, or a cubic boron nitride material, etc. The present disclosure is not limited to cutting tips comprised of any particular material.

In some embodiments, the rotary cutting tool 20 may be configured with each first tooth 46 and/or each second tooth 48 includes a cutting insert 76. For example, a cutting insert 76 may be disposed within a pocket (not shown) formed within the respective tooth and attached to the tooth by mechanical fastener 78; e.g., attached by a screw, etc. The cutting insert 76 is, therefore, removably attached to the respective tooth 46, 48 and can be replaced when desired; e.g., if worn, or if different cutting edge angles are desired, etc. For those first teeth 46 that include a cutting insert 76, the cutting insert 76 is formed (e.g., machined) to include the primary cutting edge 64 and the tertiary cutting edge 66. For those second teeth 48 that include a cutting insert 76, the cutting insert 76 is formed (e.g., machined) to include the secondary cutting edge 72. The cutting inserts 76 may comprise a different material than that of the respective tooth; e.g., the teeth 46, 48 comprising steel and the cutting inserts 76 comprising a carbide, or a polycrystalline diamond (PCD) material, or a cubic boron nitride material, etc. The present disclosure is not limited to cutting inserts 76 comprised of any particular material.

In some embodiments, the present disclosure rotary cutting tool 20 may be a one-piece structure comprising a single material throughout (e.g., the rotary cutting tool 20 is formed from a single body of material), with the possible exception of cutting tips or cutting inserts as described above.

In some embodiments, the present disclosure rotary cutting tool 20 may be an assembly formed from a plurality of elements. For example, in the diagrammatic partial cross-section shown in FIG. 10, a rotary cutting tool 20 embodiment is shown having a first portion 80 and a second portion 82. The first portion 80 includes the shank 28 and at least a segment of the body 30. The second portion 82 includes at least the second cutter head portion 38. The second portion 82 may include a stem 84 that is received within a bore 86 disposed within the first portion 80. The second portion 82 may be joined to the first portion 80 by inserting the stem 84 into the bore 86 after the first portion 80 is sufficiently heated to cause thermal expansion of the bore 86. Once the first portion 80 has sufficiently cooled, the stem 84 will be press fit within the bore 86, thereby creating a unitary rotary cutting tool 20. An advantage of this embodiment is that the first portion 80 and the second portion 82 made be formed of dissimilar materials (e.g., steel and carbide, respectively).

In some embodiments, the present disclosure rotary cutting tool 20 may include internal passages that permit the passage of cutting fluids. For example, a rotary cutting tool 20 may include one or more axial passages 88 extending from the first axial end 24, and one or more radial passages 90 that extend between the axial passage(s) 88 to the exterior of the rotary cutting tool 20. The rotary cutting tool 20 embodiments shown in FIGS. 5-8 and 10 include a plurality of radial passages 90, each exiting at an exit port 92 disposed within a respective flute 50 adjacent the respective tooth 46, 48. Cutting fluid exiting the exit port 92 washes down the discharge surface 54 of the flute 50 thereby facilitating the removal of cutting debris created within the first cutter head portion 36 by the teeth 46, 48 during operation of the rotary cutting tool 20.

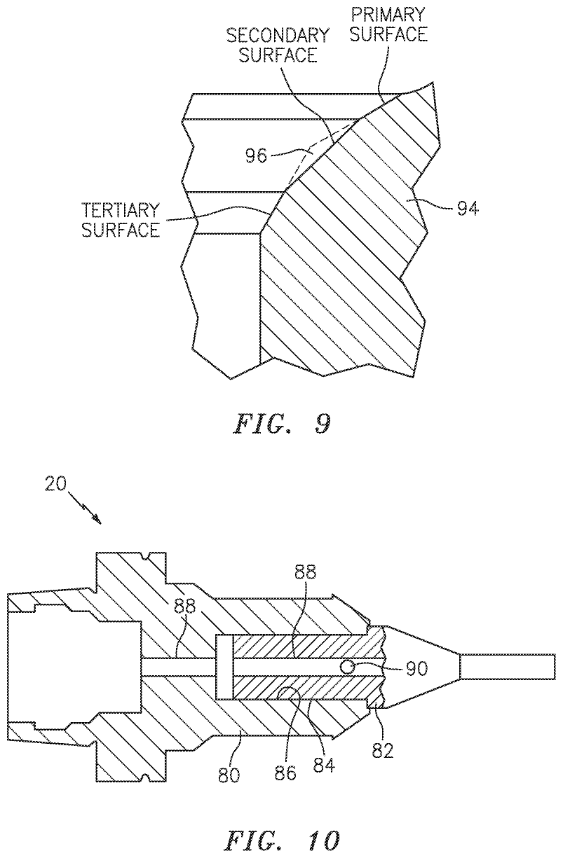

During operation of a present disclosure the rotary cutting tool 20, the rotary cutting tool 20 is mounted within a machine tool (not shown) for rotation at one or more predetermined rotational speeds and one or more axial feed rates. The axial feed rate reflects the rate of linear movement that the rotary cutting tool 20 is engaging the workpiece 94 (see FIG. 9). As the rotary cutting tool 20 is moved linearly into engagement with the workpiece 94, the first teeth 46 engage the workpiece 94 and produce a primary surface and a tertiary surface, and the second teeth 48 engage the workpiece 94 and produce a secondary surface. FIG. 9 diagrammatically illustrates a valve seat with portions of the primary and tertiary surfaces shown with dashed lines. After a first tooth 46 rotates past a point of the workpiece 94, the following second tooth 48 removes workpiece 94 material (e.g., workpiece material within the region 96 defined by the dashed lines) to establish the secondary surface. Hence, the intersection between the primary surface and the secondary surface, and the intersection between the secondary surface and the tertiary surface are formed by the collective action of the first teeth 46 and the second teeth 48.

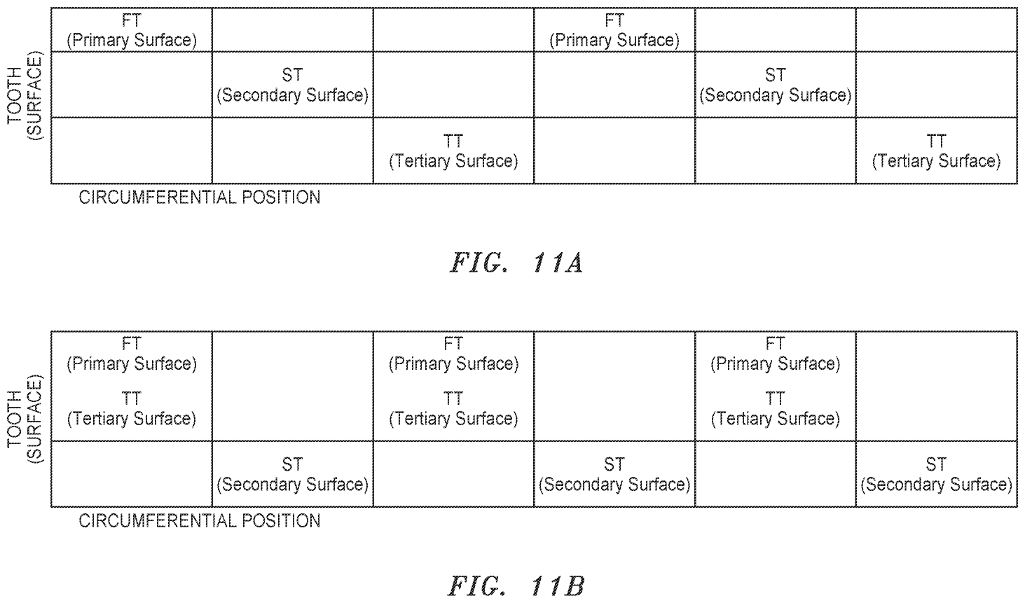

Valve seats utilized within an internal combustion engine typically have a relatively small diameter. Hence, a rotary cutting tool 20 configured to produce such a valve seat must also have a correspondingly small diameter. As stated above, conventional rotary cutting tools typically include one cutting edge per cutting tooth, and depending on the rotary cutting tool may include a single tooth per surface to be formed; e.g., a first tooth (FT) that cuts a primary surface, a second tooth (ST) that cuts a secondary surface, and a third tooth (TT) that cuts a tertiary surface, or a pair of first teeth, a pair of second teeth, and a pair of third teeth, if the tool circumference permits. FIG. 11A diagrammatically illustrates a rotary cutting tool having six teeth total; e.g., a pair of first teeth, a pair of second teeth, and a pair of third teeth. In these rotary cutting tool configurations, the total number of teeth and cutting edges are limited due to the valve seat diameter; i.e., there are only so many independent circumferential positions available.

As a general rule, the useable life of a rotary cutting tool is proportional to the number of cutting edges used to form a given surface. If for example, a rotary cutting tool includes only a single cutting edge for forming a given surface, once that cutting edge is compromised (e.g., develops micro-cracks, rounds out or otherwise changes geometry, etc.) the tool cannot be used. If the rotary cutting tool includes a pair of cutting edges for forming a given surface and one of those cutting edges is compromised, then it is likely that the tool will still be able to form the given surface within specification due to the remaining cutting edge that has not been compromised. However, once the second cutting edge is compromised, the tool likely cannot be used.

The present disclosure rotary cutting tool 20 provides a significant improvement to the prior art rotary cutting tools. For example, a tool 20 with six circumferential positions: three first teeth 46 (FT) that each cut primary and tertiary surfaces, and three second teeth 48 (ST) that each cut a secondary surface (FT, ST, FT, ST, FT, ST; see FIG. 11B). Hence, a rotary cutting tool 20 having six circumferential positions will have three cutting edges for each surface, and the useable life of the tool is improved. Another significant improvement provided by the present disclosure rotary cutting tool 20 embodiments relates to the intersections formed in the workpiece between the primary surface and the secondary surface, and between the secondary surface and the tertiary surface. The configuration of the first teeth 46 and the second teeth 48 within the present disclosure rotary cutting tool embodiments produces clean, sharp edges between the primary surface and the secondary surface, and between the secondary surface and the tertiary surface. Hence, a “full” secondary surface is formed that will ultimately be used as a sealing surface against the valve. All valves have manufacturing variability to some degree initially, and that variability can increase with wear. The clean, sharp edges between the surfaces, and the resultant “full” secondary surface created by the present disclosure rotary cutting tool are understood to provide a desirable sealing surface for a wider variety of valve conditions.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities or a space/gap between the entities that are being coupled to one another.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed:

1. A rotary cutting tool having a rotational axis, the tool comprising:
a shank; and
a body extending axially outwardly from the shank, the body having a plurality of first teeth, and a plurality of second teeth, the first teeth and second teeth are alternately arranged and spaced apart from one another around a circumference;
wherein each first tooth includes a primary cutting edge disposed at a primary angle relative to the rotational axis and a tertiary cutting edge disposed at a tertiary angle relative to the rotational axis; and
wherein each second tooth includes a secondary cutting edge disposed at a secondary angle relative to the rotational axis; and
wherein the secondary cutting edge is disposed axially between the primary cutting edge and the tertiary cutting edge.

2. The rotary cutting tool of claim 1, wherein the secondary angle is different from the primary angle and the tertiary angle.

3. The rotary cutting tool of claim 2, wherein the primary angle is different from the tertiary angle.

4. The rotary cutting angle of claim 1, wherein the primary cutting edge and the tertiary cutting edge are axially separated from one another.

5. The rotary cutting tool of claim 4, wherein the primary cutting edge and the secondary cutting edge axially intersect one another.

6. The rotary cutting tool of claim 4, wherein the tertiary cutting edge and the secondary cutting edge axially intersect one another.

7. The rotary cutting tool of claim 1, wherein the rotary cutting tool further comprises a plurality of flutes, each said flute disposed between an adjacent one said first tooth and a one said second tooth.

8. The rotary cutting tool of claim 7, further comprising one or more coolant passages extending within the body.

9. The rotary cutting tool of claim 8, wherein the one or more coolant passages includes at least one passage in fluid communication with an exit port disposed within a flute.

10. The rotary cutting tool of claim 1, wherein the tool further comprises a first axial end and a second axial end opposite the first axial end, and the shank extends between the first axial end and the body; and
the plurality of first teeth and the plurality of second teeth are disposed within a first cutter head portion, and the body includes a second cutter head portion extending from the second axial end toward the first cutter head portion.

11. The rotary cutting tool of claim 10, wherein the second cutter head portion includes a reamer.

12. The rotary cutting tool of claim 1, wherein the tool comprises a first portion and a second portion that are fixed to one another, the first portion including the shank and at least a segment of the body, wherein the first portion is formed of a first material and the second portion is formed of a second material, and the first material is different from the second material.

13. The rotary cutting tool of claim 1, wherein each first tooth includes a first tip fixed thereto, and the first tip is configured to include the primary cutting edge and the tertiary cutting edge; and
wherein each second tooth includes a second tip fixed thereto, and the second tip is configured to include the secondary cutting edge.

14. The rotary cutting tool of claim 1, wherein each first tooth includes a first cutting insert mechanically attached to the first tooth, and the first cutting insert is configured to include the primary cutting edge and the tertiary cutting edge; and
wherein each second tooth includes a second cutting insert mechanically attached to the second tooth, and the second cutting insert is configured to include the secondary cutting edge.

15. A rotary cutting tool having a rotational axis, the tool comprising:
a shank; and
a body having a plurality of first teeth and a plurality of second teeth, the first teeth and second teeth are alternately arranged and spaced apart from one another around a circumference;
wherein each first tooth includes a primary cutting edge disposed at a primary angle relative to the rotational axis and a tertiary cutting edge disposed at a tertiary angle relative to the rotational axis; and
wherein each second tooth includes a secondary cutting edge disposed at a secondary angle relative to the rotational axis; and
wherein the primary cutting edge, the secondary cutting edge, and the tertiary cutting edge are configured such that rotation of the tool and engagement of the tool into a workpiece causes:
the primary cutting edge and the secondary cutting edge to form a primary surface and a secondary surface in a work piece, the primary surface and the secondary surface contiguous with one another; and
the tertiary cutting edge to form a tertiary surface in the work piece, the secondary surface and the tertiary surface contiguous with one another; and
the primary surface axially separated from the tertiary surface.

16. The rotary cutting tool of claim 15, wherein:
the secondary angle is different from the primary angle and the tertiary angle; and
the primary angle is different from the tertiary angle; and
the primary cutting edge and the tertiary cutting edge are axially separated from one another.

17. The rotary cutting tool of claim 15, wherein the primary cutting edge and the secondary cutting edge axially intersect one another, and the tertiary cutting edge and the secondary cutting edge axially intersect one another.

18. The rotary cutting tool of claim 15, wherein the rotary cutting tool further comprises a plurality of flutes, each said flute disposed between an adjacent one said first tooth and a one said second tooth.

19. The rotary cutting tool of claim 15, wherein the tool further comprises a first axial end and a second axial end opposite the first axial end, and the shank extends between the first axial end and the body; and
the plurality of first teeth and the plurality of second teeth are disposed within a first cutter head portion, and the body includes a second cutter head portion extending from the second axial end toward the first cutter head portion.

20. The rotary cutting tool of claim 19, wherein the second cutter head portion includes a reamer.
